(19) United States
(12) Patent Application Publication
(10) Pub. No.: US 2025/0135391 A1
(43) Pub. Date: May 1, 2025

(54) Systems and Methods for Extracting A Component From A Gas

(71) Applicant: Omega Dac Inc., Katy, TX (US)

(72) Inventors: Jijun Miao, Katy, TX (US); Wei Yu, College Station, TX (US); Michael R. Berry, Katy, TX (US)

(73) Assignee: Omega Dac Inc., Katy, TX (US)

(21) Appl. No.: 18/926,321

(22) Filed: Oct. 25, 2024

Related U.S. Application Data
(60) Provisional application No. 63/545,552, filed on Oct. 25, 2023.

(51) Int. Cl. B01D 53/04; B01J 20/28

(52) U.S. Cl. CPC B01D 53/0438; B01D 53/0446; B01J 20/2808; B01J 20/28083; B01J 20/28085; B01D 2257/504; B01D 2257/80

(57) ABSTRACT

Systems and methods for extracting components from a gas. A chamber to collect water and another chamber to collect carbon dioxide from a gas are each configured with topologically optimized sorbents. A DAC method for extracting components from a gas includes water and carbon dioxide chambers configured with topologically optimized sorbents to respectively capture water and carbon dioxide.

### CROSS REFERENCE TO RELATED APPLICATIONS

This application claims priority to U.S. Provisional Patent Application No. 63/545,552 filed on Oct. 25, 2023. The entire disclosure of Application No. 63/545,552 is hereby incorporated herein by reference.

### FIELD OF THE INVENTION

The present disclosure relates generally to the field of component extraction or collection from gases. More particularly, this disclosure relates to methods and systems for direct air capture of carbon dioxide (CO₂) to reduce CO₂ emissions and atmospheric water harvesting to enhance water availability.

### BACKGROUND

According to a recent report published by the Intergovernmental Panel on Climate Change of the United Nations, efforts to reduce global warming will miss the goals of the Paris Agreement unless deep reductions in carbon dioxide (CO₂) emissions occur in the coming decades. While carbon capture is among the most effective approaches to reducing CO₂ emissions, the high cost is one of the largest barriers for existing carbon capture technologies to be widely adopted. Existing solutions often aim at improving some direct air capture (DAC) metrics while compromising others. As a result, the cost reduction from such improvements is small.

Sorbent-based DAC has been proposed for CO₂ capture techniques. However, current proposals have yet to solve the challenging and complex problems posed by such approaches to maximize the CO₂ capture efficiency. As a result, conventional DAC technologies to reduce CO₂ are not cost effective for industry adoption. Thus, a need remains for improved techniques to optimize sorbents for DAC to collect CO₂ in a more efficient and cost-effective manner.

### SUMMARY

According to an aspect of the invention, a system for extracting components from a gas includes an inlet configured to accept a gas; at least one chamber configured to collect water from the gas accepted via the inlet; at least one chamber configured to collect carbon dioxide from the gas accepted via the inlet; wherein the at least one chamber configured to collect water and the at least one chamber configured to collect carbon dioxide each comprise a topologically optimized sorbent with hierarchical pores; and wherein the at least one chamber configured to collect water and the at least one chamber configured to collect carbon dioxide are each configured to respectively release the collected water and the collected carbon dioxide.

According to another aspect of the invention, a method for extracting components from a gas includes accepting a gas via an inlet; collecting water from the accepted gas in at least one chamber configured to collect water; collecting carbon dioxide from the accepted gas in at least one chamber configured to collect carbon dioxide; wherein the at least one chamber configured to collect water and the at least one chamber configured to collect carbon dioxide each comprise a topologically optimized sorbent with hierarchical pores; and wherein the at least one chamber configured to collect water and the at least one chamber configured to collect carbon dioxide are each configured to respectively release the collected water and the collected carbon dioxide.

According to another aspect of the invention, a system for extracting components from a gas includes an inlet configured to accept a gas; at least one chamber configured to collect water from the gas accepted via the inlet; at least one chamber configured to collect carbon dioxide from the gas accepted via the inlet; wherein the at least one chamber configured to collect water and the at least one chamber configured to collect carbon dioxide each comprise a topologically optimized sorbent with hierarchical pores; and wherein the at least one chamber configured to collect water and the at least one chamber configured to collect carbon dioxide are each configured to cycle between a sorption mode and a desorption mode.

### BRIEF DESCRIPTION OF THE DRAWINGS

The following figures form part of the present specification and are included to further demonstrate certain aspects of the present disclosure and should not be used to limit the claimed subject matter. The figures are not necessarily drawn to scale, and certain features may be shown exaggerated in scale or in generalized or schematic form, in the interest of clarity and conciseness.

FIG. 1 is a flow chart of a sorbent production embodiment according to an example of the present disclosure.

FIG. 2 is a schematic of a spray freeze drying process according to an example of the present disclosure.

FIG. 3A is a schematic of binder jetting 3D printer step according to an example of the present disclosure.

FIG. 3B is a schematic of another binder jetting 3D printer step according to an example of the present disclosure.

FIG. 3C is a schematic of another binder jetting 3D printer step according to an example of the present disclosure.

FIG. 4 is a schematic of a DAC system according to an example of the present disclosure.

### DETAILED DESCRIPTION

The disclosed subject matter may be better understood by reference to one or more of the drawings in combination with the description of embodiments disclosed herein. Consequently, a more complete understanding of the present embodiments and further features and advantages thereof may be acquired by referring to the following description taken in conjunction with the accompanying drawings, in which like reference numerals may identify like elements. It should be understood, however, that the embodiments are not limited to the precise arrangements and configurations shown in the figures.

This disclosure presents innovative monolithic sorbents that have a hierarchical and interconnected pore structure, reducing the energy needed for CO₂ adsorption and desorption. Disclosed herein are topologically optimized sorbent embodiments with multiscale cavities. As used herein, the terms “sorbent” and “adsorbent” are used interchangeably. The disclosed sorbent embodiments are produced via a novel technique using binder jetting additive manufacturing (3D printing) with granulated powder.

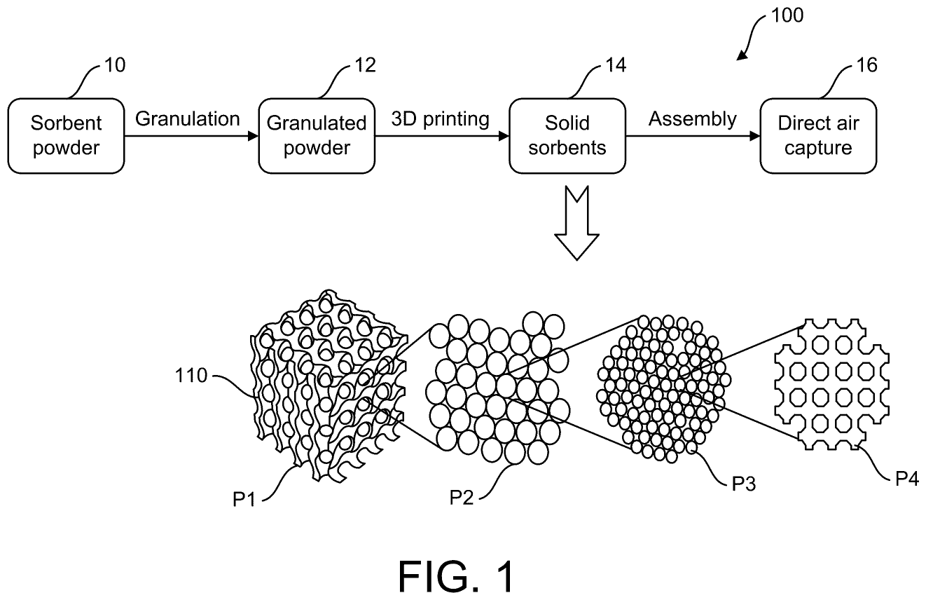

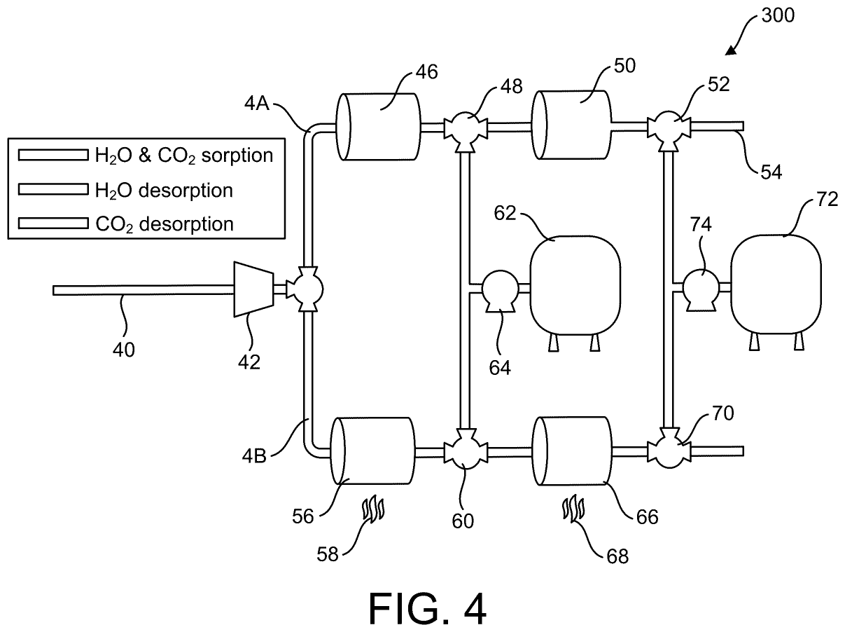

FIG. 1 shows a flow chart 100 of a sorbent production embodiment of this disclosure. At a first step 10, a feedstock powder is prepared for binder jetting additive manufacturing. At a second step 12, the feedstock powder is prepared via granulation that turns fine Zeolite particles (on the order of 1 μm) into coarse granules (on the order of 10 μm). Conducted research demonstrated that granulated powder has a significantly higher flowability compared to raw fine powder and thus results in printed parts with a smoother surface and fewer defects. Furthermore, the usage of granulated powder as the feedstock powder introduces interconnected intergranular pores. This unique characteristic is beneficial to the mass transport of CO₂ within adsorbents. Zeolite is selected for its demonstrated performance for CO₂ adsorption. It will be appreciated by those skilled in the art that other elements or compositions may be used to implement embodiments of this disclosure. At a third step 14, the granulated powder is then used for binder jetting additive manufacturing to produce monolithic adsorbents 110. At a fourth step 16, the produced sorbent embodiments are ready for integration into a commercial application (e.g., DAC system) (see FIG. 4).

The produced sorbent 110 has interconnected pores at four different scales P1, P2, P3, P4. The quadrimodal pore size distribution of the monolithic sorbent 110 embodiments is realized through different mechanisms. First, designed pores P1 on the order of 100 μm or larger are enabled by the geometric flexibility of binder jetting additive manufacturing. The shape and size of these macropores can be directly specified through computer-aided design. Second, intergranular pores P2 on the order of 10 μm are introduced by using granulated powder as the feedstock powder. Third, interparticle pores P3 on the order of 1 μm are formed between the Zeolite particles. Lastly, each Zeolite particle, as a molecular sieve, contains intraparticle pores P4 on the order of 1 nm. In some embodiments, the feedstock powder for binder jetting additive manufacturing is made of 13X Zeolite powder. This material is selected because of its demonstrated performance for CO₂ adsorption. The Zeolite powder (Product No. 283592, Sigma-Aldrich) has an average particle size of 2 μm.

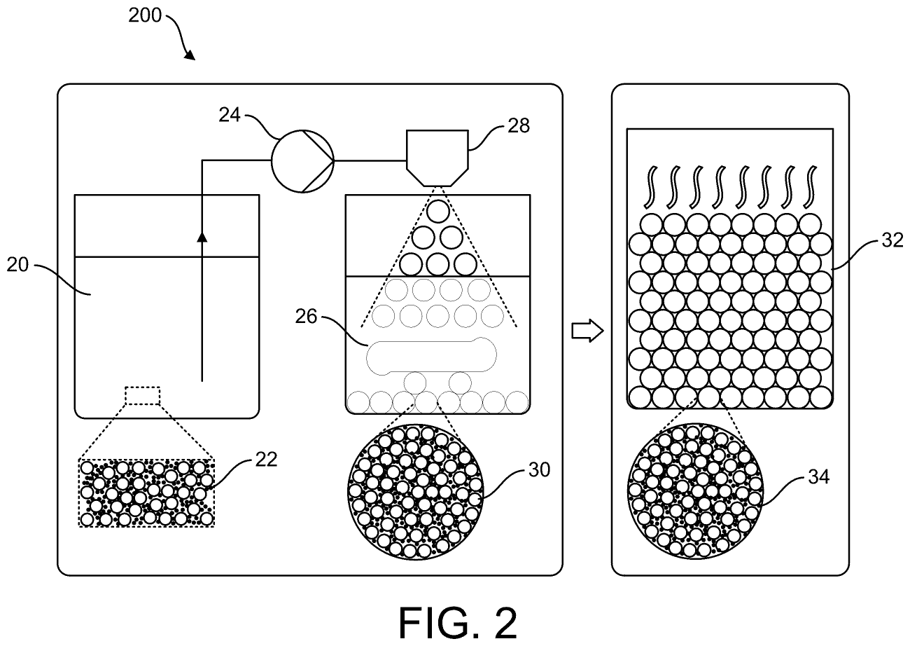

The feedstock powder for implementation of the disclosed embodiments may be prepared in more than one way. FIG. 2 shows a schematic of a spray freeze drying process 200 to prepare the feedstock powder in accordance with the present invention. First, a slurry 20 containing water and Zeolite powder 22 at a solid loading of 50 vol. % is prepared by ball milling. The slurry 20 is conveyed via a pump 24 to be sprayed into liquid nitrogen 26 by a spray freezer nozzle 28 and turned into frozen droplets 30. The frozen droplets 30 are then lyophilized in a freeze dryer 32 and turned into dry granules 34. The dry granules 34 are then sieved using a powder sieve shaker to reach a granule size of 25-53 μm. The granules 34 falling out of this range will be recycled (i.e., turned into slurry for spraying again). In addition to spray freeze drying, other granulation methods, such as spray drying, can be used for producing granules.

In some embodiments, the feedstock powder preparation parameters may be optimized by adding a dispersant (e.g. Dolapix PC 75) to the slurry 20 to reduce the viscosity for spraying. The weight ratio of the dispersant to the solid (Zeolite powder) can be tuned from 0.3% to 0.2%, 0.1%, and 0%. The smallest amount of the dispersant for successful spraying may be selected because of the lowest possibility for blocking the pores in the Zeolite. The feed rate and spraying pressure in the spray freezing step may be tuned to achieve the maximum yield. Results from testing showed that the granule size increases with increasing feed rate and decreasing spraying pressure.

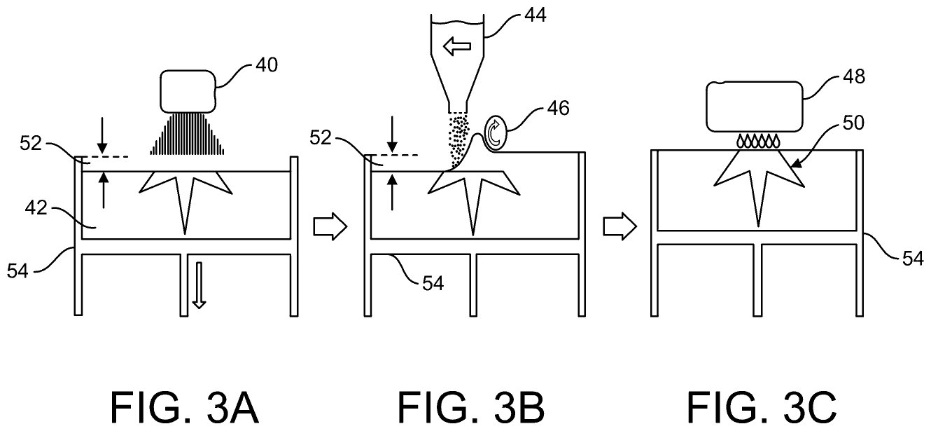

Conventional binder jetting 3D printers may be used to implement embodiments of this disclosure (e.g., ExOne Innovent+). The working principle of the 3D printers is shown in FIGS. 3A, 3B, and 3C. It has three main steps: FIG. 3A, heating the powder bed with a heat source 40 (e.g., lamp) while the build platform 42 is lowered; FIG. 3B, powder dispensing from a hopper 44 via ultrasonic vibration and powder spreading with a counter-rotating roller 46; and FIG. 3C, printing with a piezoelectric print head 48 jetting the binder to produce the printed part 50. These steps are repeated for each layer 52. After each print, the build box 54 is placed in an oven to cure the printed sorbents 110. After cooling, the sorbents 110 are obtained by removing the loose powder with compressed air in a depowdering station. The depowdered sorbents 110 may be put through debinding and sintering in a furnace if desired.

Once the topologically optimized sorbents 110 are produced as described herein, they can be integrated into a DAC application. FIG. 4 shows a schematic of a system 300 for extracting components from a gas with the sorbents 110 via DAC. Embodiments of the present disclosure may be configured to extract or capture only CO₂, only water (H₂O), or both. FIG. 4 shows an embodiment of a system 300 configured to extract both CO₂ and H₂O. Capturing H₂O as a co-product will resolve the drawback that some conventional sorbents experience as they do not work well under humid conditions. The same design (topology optimization) and 3D printing methodologies disclosed herein may be applied to produce both CO₂ and H₂O sorbents 110.

FIG. 4 shows an inlet gas line 40 with a blower 42 feeding ambient air into two identical gas lines 4A, 4B. The system 300 is shown in a state wherein valve 44 is feeding ambient air into line 4A, with line 4B shut off. In this state, the ambient air is channeled into a chamber 46 configured with the topologically optimized sorbents 110 to collect H₂O. Valve 48 then channels the dry gas from the chamber 46 to another chamber 50 configured with the topologically optimized sorbents 110 to collect CO₂. In this manner, line 4A is operating in an H₂O and CO₂ sorption mode. Valve 52 allows the dry and CO₂-depleted air to vent 54 into the atmosphere or wherever desired.

In the depicted system 300, line 4B is shut off from receiving ambient air via the inlet 40 since another chamber 56 configured with the topologically optimized sorbents 110 to collect H₂O was previously filled. The filled chamber 56 is heated with a heat source 58 to instigate the release of water from the sorbents 110, which is then channeled via valve 60 for storage in an H₂O tank 62.

In some embodiments, a pump 64 is linked to the H₂O tank to facilitate filling and/or emptying of the tank. Line 4B is also configured with a pre-filled chamber 66 configured with the topologically optimized sorbents 110 to collect CO₂. This chamber 66 is also heated with a heat source 68 to instigate the release of CO₂ from the sorbents 110, which is then channeled via valve 70 for storage in a CO₂ tank 72. In some embodiments, a pump 74 is linked to the CO₂ tank to facilitate filling and/or emptying of the tank. In this manner, line 4B is operating in an H₂O desorption mode and CO₂ desorption mode.

FIG. 4 shows one representation of a DAC system configured with the sorbent 110 embodiments of this disclosure. It will be understood that many other configurations may be implemented with multiple gas lines with multiple H₂O chambers and multiple CO₂ chambers in operation, with the gas lines in either the sorption or desorption cycle. Embodiments may also be implemented with only one H₂O chamber/storage tank and only one CO₂ chamber/storage tank. In such implementations, the system would be cycled between the sorption mode and desorption mode as described herein.

Advantages of the disclosed sorbents 110 and techniques include a reduction in cost compared to conventional CO₂ capture technologies. The topological optimization of sorbents 110 can be engineered to produce the desired multiscale cavities and pore structures. The sorbents 110 can be recycled between sorption-desorption cycles for many iterations. The embodiments may be implemented for scalable DAC and location-independent operations. The disclosed embodiments also avoid thermal and chemical degradation, evaporation, and corrosion issues seen in conventional liquid solvent capture technologies. The sorbents 110 also avoid particle attrition seen in conventional pellet-based solid sorbent capture technologies. The disclosed embodiments also save space (enabled by the increased volumetric adsorption capacity).

It will be appreciated by those skilled in the art that the disclosed embodiments may be implemented using conventional hardware, components, materials, and software and computer systems programmed to perform the disclosed processes and operations. In light of the principles and example embodiments described and illustrated herein, it will be recognized that the example embodiments can be modified in arrangement and detail without departing from such principles. It will also be appreciated that embodiments of this disclosure may be implemented for use with any gas in any environment. In view of the wide variety of useful permutations that may be readily derived from the example embodiments described herein, this detailed description is intended to be illustrative only, and should not be taken as limiting the scope of the invention.

What is claimed is:

1. A system for extracting components from a gas, comprising:
an inlet configured to accept a gas;
at least one chamber configured to collect water from the gas accepted via the inlet;
at least one chamber configured to collect carbon dioxide from the gas accepted via the inlet;
wherein the at least one chamber configured to collect water and the at least one chamber configured to collect carbon dioxide each comprise a topologically optimized sorbent with hierarchical pores; and
wherein the at least one chamber configured to collect water and the at least one chamber configured to collect carbon dioxide are each configured to respectively release the collected water and the collected carbon dioxide.

2. The system of claim 1 wherein the topologically optimized sorbent is produced by additive manufacturing.

3. The system of claim 1 wherein the topologically optimized sorbent comprises a uniform or graded lattice structure.

4. The system of claim 1 wherein the topologically optimized sorbent is configured with multiscale cavities.

5. The system of claim 4 wherein the cavities comprise different scales selected from among a smallest scale of 0.2-100 nm, a second smallest scale at least twice the smallest scale, and a third smallest scale at least twice the second smallest scale.

6. The system of claim 4 wherein the cavities comprise different scales selected from among a smallest scale of 0.2-100 nm, a second smallest scale at least twice the smallest scale, a third smallest scale at least twice the second smallest scale, and a fourth smallest scale at least twice the third smallest scale.

7. The system of claim 1 further comprising a heat source to heat the at least one chamber configured to collect water and/or the at least one chamber configured to collect carbon dioxide.

8. The system of claim 1 further comprising a plurality of valves configured to permit the at least one chamber configured to collect water and/or the at least one chamber configured to collect carbon dioxide to be switched between a sorption mode and a desorption mode.

9. The system of claim 1 further comprising at least one pump linked to the at least one chamber configured to collect water or the at least one chamber configured to collect carbon dioxide.

10. The system of claim 1 wherein the topologically optimized sorbent is produced using a dispersant agent.

11. A method for extracting components from a gas, comprising:
accepting a gas via an inlet;
collecting water from the accepted gas in at least one chamber configured to collect water;
collecting carbon dioxide from the accepted gas in at least one chamber configured to collect carbon dioxide;
wherein the at least one chamber configured to collect water and the at least one chamber configured to collect carbon dioxide each comprise a topologically optimized sorbent with hierarchical pores; and
wherein the at least one chamber configured to collect water and the at least one chamber configured to collect carbon dioxide are each configured to respectively release the collected water and the collected carbon dioxide.

12. The method of claim 11 wherein the topologically optimized sorbent is produced by additive manufacturing.

13. The method of claim 11 wherein the topologically optimized sorbent comprises a uniform or graded lattice structure.

14. The method of claim 11 wherein the topologically optimized sorbent is configured with multiscale cavities.

15. The method of claim 14 wherein the cavities comprise different scales selected from among a smallest scale of 0.2-100 nm, a second smallest scale at least twice the smallest scale, and a third smallest scale at least twice the second smallest scale.

16. The method of claim 11 further comprising heating the at least one chamber configured to collect water and/or the at least one chamber configured to collect carbon dioxide to respectively release the collected water and/or the collected carbon dioxide.

17. The method of claim 11 further comprising switching the at least one chamber configured to collect water and/or the at least one chamber configured to collect carbon dioxide between a sorption mode and a desorption mode.

18. The method of claim 11 further comprising storing the water collected by the at least one chamber configured to collect water and/or storing the carbon dioxide collected by the at least one chamber configured to collect carbon dioxide.

19. The method of claim 18 wherein a pump is linked to the at least one chamber configured to collect water or to the at least one chamber configured to collect carbon dioxide to facilitate the respective storage of the water or the carbon dioxide.

20. A system for extracting components from a gas, comprising:
an inlet configured to accept a gas;
at least one chamber configured to collect water from the gas accepted via the inlet;
at least one chamber configured to collect carbon dioxide from the gas accepted via the inlet;
wherein the at least one chamber configured to collect water and the at least one chamber configured to collect carbon dioxide each comprise a topologically optimized sorbent with hierarchical pores; and
wherein the at least one chamber configured to collect water and the at least one chamber configured to collect carbon dioxide are each configured to cycle between a sorption mode and a desorption mode.
